(19) United States
(12) Patent Application Publication
(10) Pub. No.: US 2007/0209747 A1
(43) Pub. Date: Sep. 13, 2007

(54) Photoluminescent Adhesive, Signs, Using Photoluminescent Adhesives and Method of Making a Photoluminescent Adhesive

(75) Inventors: Richard T. Merle, Crystal Lake, IL (US); John D. Campbell, La Jolla, CA (US); Robert W. Jessup, McHenry, IL (US)

Correspondence Address: WILDMAN HARROLD ALLEN & DIXON, 225 WEST WACKER DRIVE, SUITE 2800, CHICAGO, IL, 60606, US

(73) Assignee: Jessup Manufacturing Company, McHenry, IL (US)

(21) Appl. No.: 11/749,269

(22) Filed: May 16, 2007

Related U.S. Application Data
(62) Division of application No. 10/987,357, filed on Nov. 12, 2004.
(60) Provisional application No. 60/523,529, filed on Nov. 19, 2003.

(51) Int. Cl. C09K 11/02

(52) U.S. Cl. 156/67

(57) ABSTRACT

The present invention is directed to a method of producing a photoluminescent adhesive for use in manufacturing signs which emit light in the dark after being exposed to ambient light by using photoluminescent adhesives. The sign comprises a clear acrylic substrate, a photoluminescent adhesive placed over the substrate and a protective layer over the photoluminescent adhesive.

### CROSS-REFERENCE TO RELATED APPLICATIONS

This application is a divisional of co-pending U.S. patent application Ser. No. 10/987,357, filed Nov. 12, 2004, which claims priority from U.S. Provisional Application No. 60/523,529 filed Nov. 19, 2003.

### BACKGROUND OF THE INVENTION

The present invention relates, in general, to the field of adhesives and signs. More specifically, the present invention is directed to signs which utilize photoluminescent adhesives.

The present invention overcomes the shortcomings and the deficiencies of the prior art and is directed to signs which incorporate photoluminescent adhesives and which solve or at least substantially reduce the impact of these problems associated with existing signs.

Various types of illuminated signs are well-known and commonly used for indicating location of safety equipment and other objects, showing directions for normal or emergency egress and providing warnings. These signs act as important safety measures particularly during emergencies. Existing signs require electricity or other source of power to illuminate and/or display the information contained therein. However, such conventional signs are deficient in several ways.

Conventional signs require electrical wiring or batteries as sources of power for illumination. Installation and maintenance of existing signs is expensive because it typically requires specialized individuals such as electricians. Additionally, existing signs are expensive to operate because electricity must be paid for. This is especially true with emergency signs which must be illuminated at all times and thus require a constant supply of electricity. Moreover, signs which use batteries are also expensive because batteries must be constantly replaced. Therefore, there is a need for signs which use an inexpensive source of illumination, and one which is not dependent upon electrical power.

In addition, conventional signs are placed in specialized locations because they are expensive and can create hazardous conditions. For example, existing signs are typically hung from a ceiling or towards the top of a wall. Moreover, they need to be typically protected from ceiling sprinklers or water distribution systems in a building. Furthermore, when existing signs are broken or are malfunctioning they create potentially dangerous electrical hazards. As a result, there is a need for signs that are less hazardous.

Furthermore, there is a need for signs that may be installed in various locations such as by door handles or at eye level on walls which locations may be more convenient for viewing. This is especially important in situations such as in handicapped friendly rooms and restrooms where it could be difficult or impossible for individuals to view a sign placed towards the top of a wall.

Finally, it may be undesirable in certain circumstances to have to constantly supply power to the signs. For example, it may be undesirable for airlines to constantly illuminate power strips along the floor of an aircraft because they may wish to conserve the power for other equipment such as emergency reserve systems.

Although alternative illumination sources such as photoluminescent sign bodies have been recently contemplated, these signs require additional manufacturing expenses because special photoluminescent material must be incorporated into the signs in addition to the adhesive and other parts. This incorporation increases the production steps thereby decreasing productivity. Finally, the photoluminescent material must also be housed in a special enclosure. Hence, there is a need for signs which overcome such problems.

One object and advantage of the present invention is to provide a sign which is inexpensive to install and maintain.

It is another object and advantage of the present invention to provide a sign which may be installed in any location without connection to electrical power.

It is still another object and advantage of the present invention to provide a sign which is safer than conventional signs.

It is yet another object and advantage of the present invention to provide a sign which is self illuminating.

The above and other objects, advantages, and features of the present invention will become readily appreciated and understood from consideration of the following detailed description of the preferred embodiments of the present invention.

### SUMMARY OF THE INVENTION

In accordance with the foregoing objects, in the preferred exemplary embodiment, the present invention is directed to a sign comprising a substrate having a viewing surface, a photoluminescent adhesive which emits light after exposure to mere ambient light, and a protective layer over the adhesive.

The preferred exemplary embodiment of the present invention provides several advantages over the existing signs. The present invention uses any conventional substrate comprising glass, plastic, foil, paper, or any other material. Moreover, the substrate may be rigid or flexible as desired. This is advantageous because this significantly reduces the cost of not only producing the sign but also the cost of the sign itself. Additionally, the sign, as proposed in the preferred exemplary embodiment of the present invention, may be adopted for use in any location such as on flexible surfaces as well as on rigid surfaces. For example, the signs of the present invention may be placed on cloth, paper, doors or walls.

In addition, the preferred exemplary embodiment of the invention utilizes a photoluminescent adhesive that is capable of emitting light after being exposed to ambient light. This is beneficial because this substantially reduces the costs associated with electrical and battery operated systems. Furthermore, since the adhesive itself is photoluminescent, costs of production of the signs are significantly reduced. No separate procedures, equipment or materials are required to add a photoluminescent resin as is needed in the prior art.

### BRIEF DESCRIPTION OF THE DRAWINGS

FIG. 1 illustrates a sign as in the prior art;

FIG. 2 is a front view of the prior art sign under lighted conditions;

FIG. 3 is a front view of the prior art sign under unlighted/dark conditions;

FIG. 4 shows a sign with the photoluminescent adhesive;

FIG. 5 shows the photoluminescent sign as if appearing under lighted conditions;

FIG. 6 shows the photoluminescent sign as if appearing under unlighted/dark conditions;

FIG. 7 shows a photoluminescent sign with two substrates;

FIG. 8 shows a photoluminescent sign with subsurface printing on a second face;

FIG. 9 shows a photoluminescent sign wherein a message is present on the photoluminescent adhesive;

FIG. 10 is a front view of the photoluminescent sign of FIG. 9;

FIG. 11 shows a photoluminescent sign with a protective layer.

### DETAILED DESCRIPTION OF THE INVENTION

While various embodiments of the present invention are discussed in detail below, it should be appreciated that the present invention provides inventive concepts that can be embodied in wide variety of specific contexts. The specific embodiments discussed are merely illustrative of specific ways to make and use the invention and do not limit the scope of the invention.

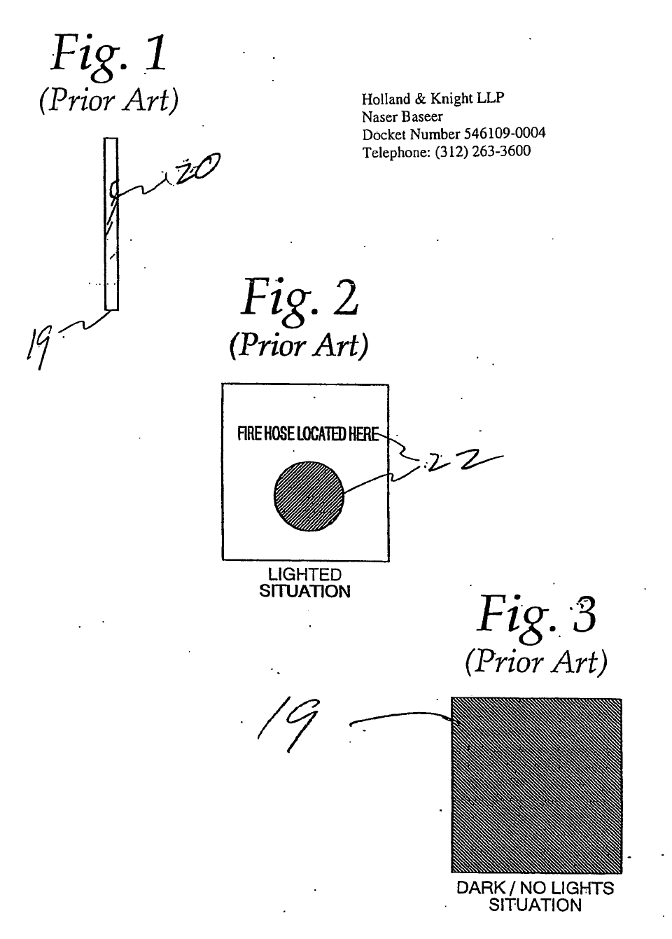

Turning first to FIGS. 1 and 2, a sign 19 found in the prior art may comprise an acrylic substrate 20 with subsurface printing 22. As shown in FIG. 2, such signs competently display a printed message 22 under lighted conditions or when they are internally lighted by electric power source or batteries. However, as can be seen in FIG. 3, existing signs cannot display any message and become useless under dark and unlighted conditions.

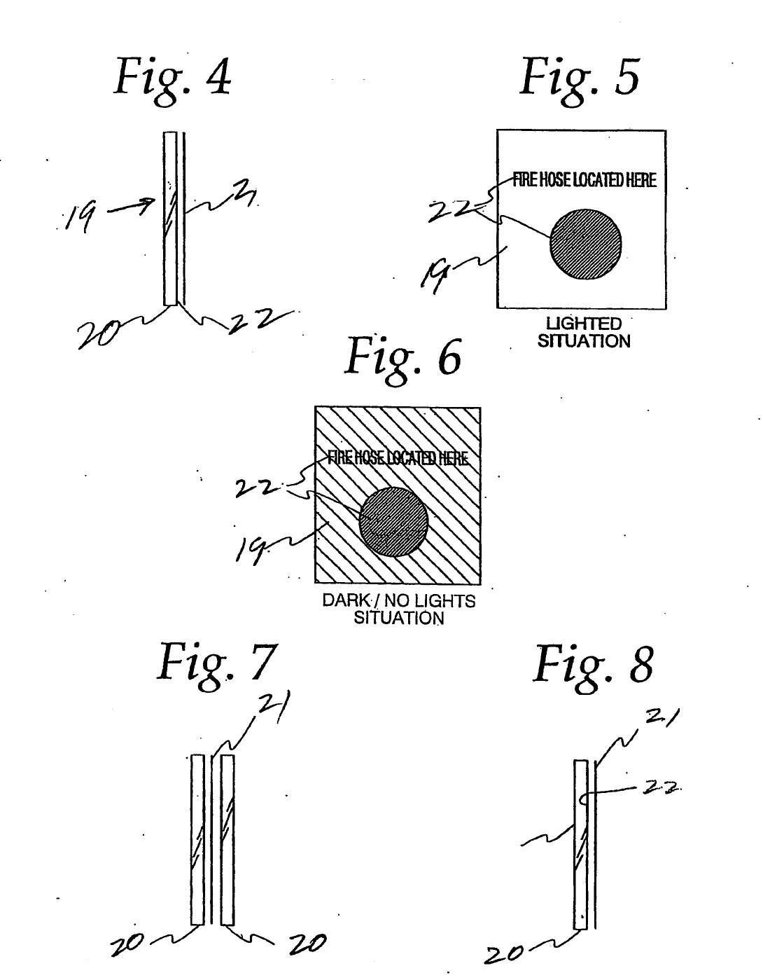

FIG. 4 displays a photoluminescent sign that is the preferred exemplary embodiment of the present invention. The preferred exemplary embodiment of the present invention comprises a clear acrylic substrate 20. Although, the preferred exemplary embodiment uses clear acrylic, the substrate 20 of the present invention may comprise any object or material that is able to receive the photoluminescent adhesive. The substrate 20 may be a rigid or a flexible substrate. For example, the substrate 20 may be an individual piece of foil, film, cloth, plastic, glass, polyester, paper or any other transparent, translucent or opaque material. The substrate 20 provides support and structure for the sign 19.

In the preferred exemplary embodiment of the invention, the desired writing, picture, symbol, or other type of message 22 is also printed or engraved on a front surface of the substrate 20. In the preferred exemplary embodiment, the photoluminescent adhesive 21 is placed directly on and covers the entire front surface and the message 22. As shown in FIGS. 5 and 6, the signs of the present invention are visible in either lighted or dark conditions.

In addition, as in FIG. 7, the substrate 20 may be two sheets of material or two objects which encapsulate the photoluminescent adhesive 21 between them. If two sheets or two objects comprise the substrate 20, it is preferable that at least one surface be translucent to allow the photoluminescent adhesive 21 to be visible.

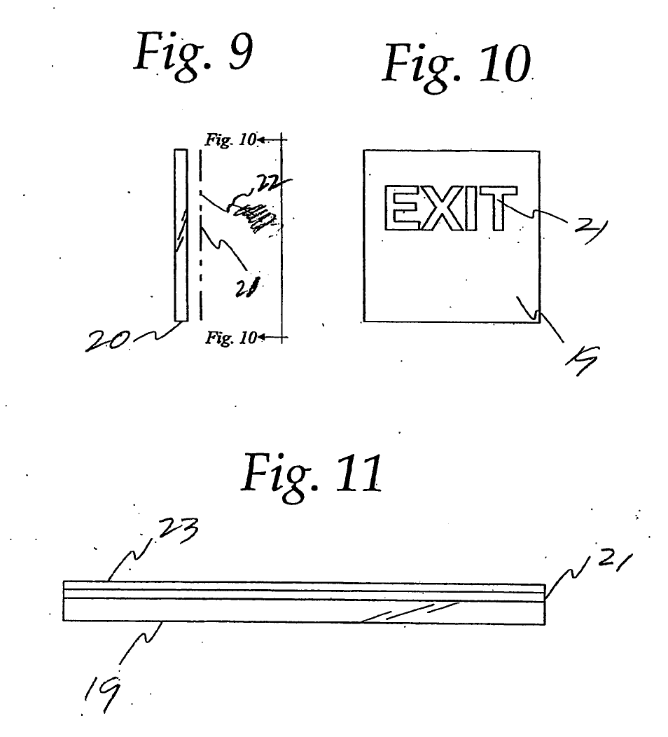

Turning next to FIG. 8, it should be appreciated by those or ordinary skill in the art that the message 22 may be printed or engraved on any surface of the substrate 20 including any surface of any sheet in a multiple sheet substrate as long as it can be seen. Additionally, it should also be appreciated by those of ordinary skill in the art that the message may be outlined in the photoluminescent adhesive 21, as in FIG. 9, without being printed on the substrate 20 as well as both printed on the substrate 20 and outlined in the photoluminescent adhesive 21. For example, FIG. 10 displays a photoluminescent sign 19 wherein the message 22 is outlined in the photoluminescent adhesive 21.

In the preferred exemplary embodiment of the invention, the sign 19 comprises a photoluminescent adhesive 21 comprises photoluminescent pigment such as strontium aluminate or zinc sulfide, a pressure sensitive solvent based acrylic adhesive, and a metallized polyester carrier. The photoluminescent adhesive 21 is a glow-in-the-dark adhesive that is capable of being laminated onto a substrate 20 such as an acrylic substrate or a polyester substrate to allow the substrate 20 to emit light in total darkness. The opaque metallized polyester carrier holds the adhesive and ensures consistent glow characteristics by blocking out all background variations.

Although the preferred exemplary embodiment uses strontium aluminate or zinc sulfide as the pigment, it should be appreciated by those or ordinary skill in the art that other photoluminescent pigments which may be combined with the desired adhesive may be utilized. Furthermore, it should also be appreciated that other types of pressure sensitive adhesives such as rubber or water based adhesives may also be used. Moreover, non-pressure sensitive adhesives such as heat, solvent, or water activated adhesives may also be used in the present invention. In addition, the substrate 20 may further comprise any film, paper, foil, or other flexible material. Furthermore, the substrate 20 may be colored. Finally, it should be noted that, in the present invention, the photoluminescent adhesive 21 may only comprise the photoluminescent pigment and the adhesive without the carrier.

Turning to FIG. 11, in the preferred exemplary embodiment of the invention, a protective layer 23, which is compatible with the adhesive mixture, is placed over the photoluminescent adhesive 21. The protective layer 23 may comprise a release liner or the carrier. It protects the adhesive during storage and transportation of the sign. The protective layer may be removed prior to the attachment of the sign onto a surface. However, it should be appreciated that the protective layer is not necessary to practice the invention.

In a preferred exemplary embodiment, the photoluminescent adhesive 21 of the present invention is produced by suspending the pigment in the adhesive and blending both to achieve a consistent homogenous solution. In the preferred exemplary embodiment, the photoluminescent pigment comprises 30%-40% by weight and the adhesive comprises 60%-70% by weight. The pigment and the adhesive are mixed until the solution reaches the desired viscosity of 4500-6000 centipoises. Additionally, a solvent such as xylene may be added to cut the viscosity to achieve the desired result. Nonetheless, the pigment to adhesive ratio as well as the viscosity may be varied according to the desired characteristics and performance of the final product. Finally, this solution may also vary depending on the specific adhesive, pigment, or processing equipment that is used.

After mixing, in the preferred exemplary embodiment, a uniform coat of the solution is cast onto the release liner and drawn through an oven at 1-30 ft./min. at 120-170° F. The oven evaporates the solvent and leaves the desired photoluminescent adhesive. It should be appreciated by those of ordinary skill in the art that the solution may be cast directly on the substrate if no release liner is used during production. Moreover, it should be appreciated by those of ordinary skill in the art that the curing process may vary depending on the adhesive system and processing equipment.

Finally, the process comprises laminating the release liner to the substrate film. However, it should be noted that this is unnecessary where no release liner is used and the solution is cast directly onto the substrate.

The specific embodiments discussed in the detailed description are merely illustrate of specific ways to make and use the invention, and do not limit the scope of the invention.

The invention is claimed as follows:

1. A method for producing a photoluminescent adhesive comprising,
mixing a photoluminescent pigment and an adhesive into a solution; and
casting the solution onto a substrate.

2. A method for producing a photoluminescent adhesive as in claim 1 where said photoluminescent pigment comprises 30%-40% by weight and said adhesive comprises 60%-70% by weight.

3. A method for producing a photoluminescent adhesive as in claim 1 where said solution is mixed to achieve a preferred viscosity of 4500-6000 centipoises.

4. A method for producing a photoluminescent adhesive as in claim 3 further comprising adding solvent to said solution to achieve said preferred viscosity.

5. A method for producing a photoluminescent adhesive as in claim 4 further comprising drawing said solution through an oven after achieving said preferred viscosity.

6. A method for producing a photoluminescent adhesive comprising,
mixing a photoluminescent pigment and an adhesive into a solution;
casting the solution onto a protective layer; and
laminating said protective layer to a substrate.

7. A method for producing a photoluminescent adhesive as in claim 6 where said photoluminescent pigment comprises 30%-40% by weight and said adhesive comprises 60%-70% by weight.

8. A method for producing a photoluminescent adhesive as in claim 7 where said solution is mixed to achieve a preferred viscosity of 4500-6000 centipioses.

9. A method for producing a photoluminescent adhesive as in claim 8 further comprising adding solvent to said solution to achieve said preferred viscosity.

10. A method for producing a photoluminescent adhesive as in claim 9 further comprising drawing said solution through an oven after achieving said preferred viscosity.
